(19) United States
(12) Patent Application Publication
(10) Pub. No.: US 2009/0316250 A1
(43) Pub. Date: Dec. 24, 2009

(54) Window having wavelength selectivity and photovoltaic capability

(76) Inventors: Lee Boman, Belmont, CA (US); Richard T. Wipfler, Menlo Park, CA (US)

Correspondence Address: SCHNECK & SCHNECK, P.O. BOX 2-E, SAN JOSE, CA, 95109-0005, US

(21) Appl. No.: 12/214,279

(22) Filed: Jun. 18, 2008

(51) Int. Cl. G02F 1/153

(52) U.S. Cl. 359/275

(57) ABSTRACT

A generally transparent solar cell or solar cell array is formed on a tensioned flexible substrate located between parallel rigid transparent members. Layers are formed on the tensioned flexible substrate so as to include both filter layers which are cooperative to provide desired wavelength-filtering properties and power-generating layers which are cooperative to provide photovoltaic properties. In the embodiments in which the power-generating layers form an organic solar cell, one or both of the spaces between the substrate and the rigid transparent members contain a fixed volume of gas, so that deterioration of the layers as a consequence of exposure to moisture is retarded.

### TECHNICAL FIELD

The invention relates generally to windows for use along the wall of a residence or commercial structure and more particularly to windows which provide multiple capabilities, such as energy generation and wavelength selectivity.

### BACKGROUND ART

Devices which convert solar energy into electrical energy are referred to by various terms, such as solar cells, photovoltaic cells, and optoelectric devices. Briefly stated, such a device converts photons of incident solar energy to charge carriers which are then used to generate useful electrical energy.

Currently, the dominant technology for designing and fabricating solar cells is based upon the use of semiconductors. Suitable materials include silicon (crystalline, polycrystalline or amorphous), gallium arsenide, and cadmium telluride. The semiconductor-based solar cells are attractive because of their relatively high efficiency with respect to photovoltaic conversion. It is possible to reach photovoltaic conversion efficiencies of thirty-seven percent.

A “competing” technology in the design and fabrication of solar cells is based upon the use of organic materials. There are five basic types of organic (excitonic) solar cells, namely polymer-acceptor, polymer-inorganic nanoparticle, small molecule heterojunctions, dye-sensitive, and organic-inorganic hybrid. However, the development of organic solar cells is still in its infancy.

As compared to semiconductor-based devices, the organic-based solar cells are lightweight and inexpensive to manufacture. Moreover, the potential negative environmental impact as a consequence of the fabrication process is reduced. For some applications, another advantage is that organic solar cells may be formed on flexible substrates, such as polyethylene terephthalate (PET).

There are two concerns with the use of organic solar cells. Firstly, such devices tend to have a much lower photovoltaic conversion efficiency. As compared to the thirty-seven percent efficiency of semiconductor-based solar cells, the organic-based solar cells currently have an efficiency of six percent or less. The greater concern over time is that organic-based solar cells are more susceptible to rapid degradation resulting from exposure to moisture.

Because of the drawbacks associated with organic solar cells, the focus remains upon semiconductor-based devices. This is true both in applications in which electrical energy is generated to provide power for unrelated devices and applications in which solar cells are integrated with the device to be powered. For example, U.S. Pat. No. 5,805,330 to Byker et al. describes a semiconductor-based solar cell that is incorporated into a window that requires electrical power to selectively change its transmissivity. The Byker et al. window is electrochromic, which is sometimes referred to as being a “smart window,” since its tint can be changed by applying and removing an electrical charge. Byker et al. teaches that photovoltaic cells may be included in order to allow the electrochromic window to be self-powering and auto-matic. A photovoltaic assembly may be placed between two glass elements at an edge of the window. Alternatively, the photovoltaic assembly may be placed within the window area and may be in the form of a decorative design. When light impinges on the photovoltaic assembly, an electrical potential is generated for application to the transparent conductive layers that provide the electrochromic capability. Consequently, the window is darkened or lightened in proportion to changes in the intensity of impinging light.

The self-powered electrochromic window described in Byker et al. operates well for its intended purpose. However, further advances are sought. Because the photocells are opaque, they must be placed at the edge of the window, unless they are used in the formation of a decorative design. Regardless, the percentage of window area that is dedicated to power generation must be limited.

It would be beneficial to provide large scale solar cells which do not require dedicated spaces (such as rooftops) and which provide the advantages of organic solar cells without susceptibility to rapid degradation.

### SUMMARY OF THE INVENTION

In accordance with the present invention, at least one large area solar cell is formed on a tensioned flexible substrate located between first and second parallel rigid transparent members, such as panes of glass. A number of layers are formed on the tensioned flexible substrate, including filter layers which are cooperative to provide desired wavelength-filtering properties and power-generating layers which are cooperative to provide photovoltaic properties. On opposite sides of the tensioned flexible substrate are fixed volumes of gas. The transmissivity with respect to visible light along a path that intersects both the filter layers and the power-generating layers is at least twenty percent, thereby enabling the assembly to be used as a window along a wall of a structure, such as a residence or an office building. Preferably, the addition of the power-generating layers does not significantly affect the visual perception of a person viewing through the window, as compared to conventional windows which utilize only wavelength filtering. The preferred embodiment is one in which the power-generating layers comprise materials which define an organic solar cell.

The organic solar cell or cells formed on the tensioned flexible substrate are protected from moisture as a result of the fixed volumes of gas on opposite sides of the substrate. The areas between the flexible substrate and the two rigid transparent substrates may be sealed, so as to provide protection against moisture. Protection is enhanced if one or both of the sealed areas is a trapped pocket of inert gas, such as a gas that is primarily argon.

The larger the area in which the power-generating layers reside within the viewing area of a window, the greater the amount of energy generated by the window from incident light. Since the power-generating layers are formed so as to allow a person to view through the layers, the solar cell capability can occupy nearly the entirety of the window area. Preferably, the power-generating layers occupy at least fifty percent of the viewing area of the window. The power-generating layers may form a single solar cell or an array of contributing solar cells.

Structural enhancements may be provided to increase the efficiency of the solar cell or solar cells, as compared to a mere conventional stack of power-generating layers. In one embodiment, the layers on the tensioned flexible substrate include reflective layers positioned to redirect light to the solar cell. At least one of the layers may include surface irregularities configured to induce light scattering which enhances power-generating efficiency. Other means for tailoring layers to increase photon collection and/or direction may be utilized. In some applications of the invention, the exposed (outermost) surface of the plurality of layers exhibits low emissivity with respect to radiation of heat (i.e., a Low E surface). This Low E surface should face the exterior of the structure to which the window is attached.

While the layers have been described as being filter layers and power-generating layers, it is possible to use at least one common layer in accomplishing both the wavelength filtering and the power generation. As one possibility, an electrode layer of an organic solar cell is also a conductive layer of a solar control stack. The solar control stack may be comprised of alternating dielectric and conductive layers.

### BRIEF DESCRIPTION OF THE DRAWINGS

FIG. 1 is a partial side sectional view of a window formed in accordance with one embodiment of the invention.

FIG. 2 is a representation of an embodiment of the components which form the transparent optical path through the window of FIG. 1.

FIG. 3 is a side view of one possible application of the layer stacks of FIG. 2.

FIG. 4 is a representation of a window having four large-scale organic solar cells.

FIG. 5 is a schematic representation of the four solar cells of FIG. 4 connected in parallel.

FIG. 6 is a schematic representation of the four solar cells of FIG. 4 connected in series.

### DETAILED DESCRIPTION

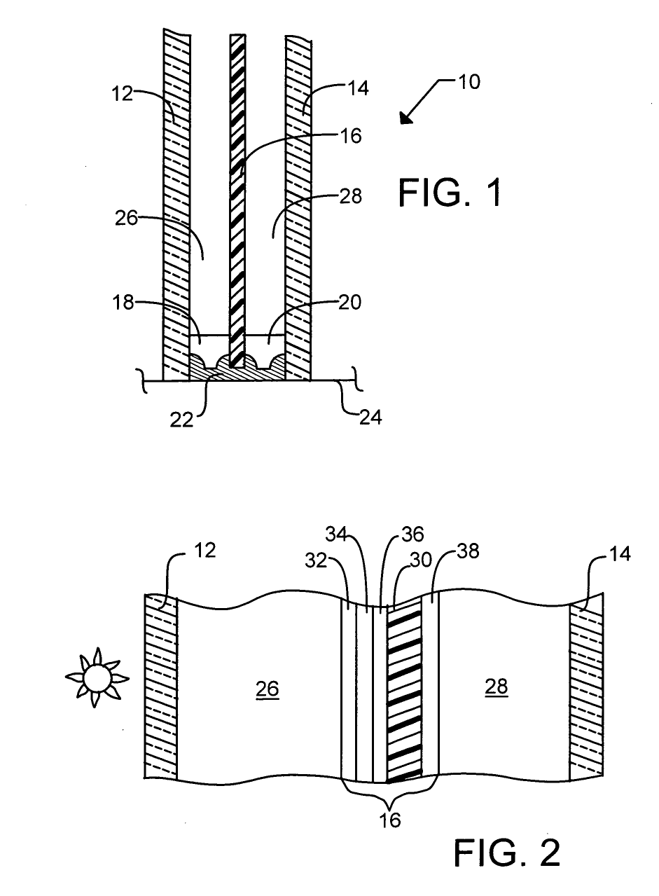

With reference to FIG. 1, a lower portion of a window 10 having photovoltaic capability is shown as including a pair of rigid transparent members 12 and 14 on opposite sides of a tensioned flexible substrate 16. The end members 12 and 14 may be parallel glass panes, but rigid polymeric members provide a suitable alternative. The center substrate 16 includes a flexible plastic sheet that does not degrade as a result of prolonged sun exposure. Another requirement is that the plastic sheet must be formed of a material which allows a layer stack to be formed on at least one surface, as will be described below. A suitable material is polyethylene terephthalate (PET).

In the embodiment of FIG. 1, the tensioned flexible substrate 16 is secured in position between the two rigid transparent members 12 and 14 by a pair of spacers 18 and 20. The spacers may be metallic or plastic. A sealant 22, such as a silicon resin, is used to secure the components, so that a moisture-tight assembly is provided. Typically, the assembly is secured within a frame prior to attachment to a structure 24, such as a building or a residence. Further details regarding the assembly are described in U.S. Pat. No. 5,784,853 to Hood et al., which is assigned to the assignee of the present invention, or in U.S. Pat. No. 4,335,166 to Lizardo et al.

The tensioned flexible substrate 16 is separated from the two rigid transparent members 12 and 14 by voids 26 and 28. Each void contains a fixed volume of gas. Particularly for embodiments of the invention in which power-generating layers on the tensioned flexible substrate define an organic solar cell, one or both voids is a trapped volume of a dry inert gas, such as argon. In addition to argon, other inert, low-heat transfer gases may be used, including krypton, sulfur hexafluoride and carbon dioxide. A small amount of oxygen (preferably in the range of one percent to ten percent by volume) may be included in order to reduce any susceptibility of the substrate 10 to yellowing.

The tensioned flexible substrate 16 may be heat shrinkable. Heat treatment during a fabrication process may simultaneously cure the sealant 22 and shrink the substrate to a taut condition. That is, heat shrinking may be employed to cause the mounted flexible substrate to become “tensioned.” For example, the substrate 16 may include a PET sheet that allows the deposition of various layer stacks during web processing. Following the web processing, the PET is cut to the appropriate dimensions for forming a number of windows 10 as shown in FIG. 1.

The layers that are formed on the flexible substrate include both filter layers that are cooperative to provide desired wavelength filtering properties and power-generating layers that are cooperative to provide photovoltaic properties. Since the assembly must function as a window, the transmissivity of visible light along the path that intersects both the filter layers and the power-generating layers is at least twenty percent. Transmissivity of many conventional windows for use in buildings or residences is in the range of twenty percent to fifty percent. Preferably, the addition of the power-generating layers has little or no effect on the perception of a person viewing through the window.

FIG. 2 includes a representation of one embodiment of the components of the tensioned flexible substrate 16. The various layers are formed on a generally transparent sheet, such as a PET sheet 30. The thickness of the sheet accommodates roll-to-roll processing during the formation of the layers. In this embodiment, the rigid transparent members 12 and 14 are glass, with transparent member 12 being at the exterior of a building or residence and transparent member 14 being the interface to the interior of the structure. A layer stack 32 closest to the exterior provides wavelength filtering. This layer stack may be a heat mirror stack (such as that sold by Southwall Technologies, Inc. as HM 88) or a solar control stack (such as sold by Southwall Technologies, Inc. as SC 75). The layer stack may define a Fabry-Perot filter in which alternating dielectric and metallic layers are formed.

A second layer stack 34 comprises the power-generating layers. That is, the second layer stack is a solar cell or an array of solar cells. In many applications, the second layer stack occupies nearly the entirety of the window 10 as shown in FIG. 1. The photovoltaic capability preferably involves more than fifty percent of the window area and more preferably at least ninety percent of the window area. One large area solar cell is likely to be inefficient, since carrier collection from the central region of the solar cell to an output at an edge of the window almost necessarily involves inefficiencies. Thus, efficiency can be improved by patterning the second layer stack to form an array of solar cells. Each cell within the array may have a separate output, or the cells may be interconnected. Interconnection of solar cells is known in the art.

The solar cell or cell array formed by the second layer stack 34 generates power for a device unrelated to the window 10. For example, generated power may be stored for subsequent use, such as to provide nighttime lighting. As another example, the generated power may be used to partially or wholly drive air conditioning equipment, particularly if a large number of power generating windows are employed on a single structure, such as a residence.

Since the second layer stack 34 occupies a significant percentage of the viewing area through the window 10, its optical properties are significant. In many conventional windows that do not utilize the power-generating capability, the transmissivity of visible light is within the range of twenty percent to fifty percent, with transmissivity of wavelengths outside of the visible light spectrum being even lower. Wavelength filtering is based upon various factors, but particularly energy consciousness. Solar shading can be used to significantly reduce cooling expenses. Ultraviolet rejection provides a reduction in fading of furniture and carpeting within the interior of a residence or office. On the other hand, the design of the second layer stack typically includes attempting to minimize the optical effects imposed by the incorporation of the photovoltaic capability. Alternatively, the design may be intended to provide cooperation of the layer stacks 32 and 34 to achieve the desired optical properties. Where the second layer stack is patterned to provide more than one solar cell, the visibility of the area between adjacent solar cells should be minimized. This may be achieved by patterning only one of the layers within the stack, such as the patterning of a carrier-collection layer of silver (i.e., patterning only the electrode).

The tailoring of optical properties of the window 10 may be further enhanced by providing a third layer stack, although the use of additional wavelength filtering may not be significant in many applications. As an alternative, this third layer “stack” 36 may be a single layer of a metallic material functioning as a partial mirror to increase the photon collection by the solar cell or solar cells. For example, a film of silver may be formed on the surface of the PET sheet 30 to provide reflection of a portion of the solar energy back into the second layer stack 34, without a significant adverse effect on the viewing capability through the window 10. In some applications, a fourth layer stack 38 may be formed on the interior side of the PET sheet.

As an early step in the design of the window 10, the desired solar properties are identified. The window 10 has a high neutrality within the visible light spectrum, so as to maximize clarity. As previously noted, the transmissivity within the visible light range is greater than twenty percent. Preferably, the transmissivity within this wavelength range is between fifty percent and eighty percent. The reflectivity of visible light is relatively low (for example, five percent to twenty percent), but reflectivity of light by layers that are interior relative to the solar cell or cells may function to improve power generation. In some applications, the exposed surface or surfaces (i.e., the outermost and innermost surfaces) of the tensioned flexible substrate 16 exhibit low emissivity with respect to the radiation of heat. That is, one or both exposed surfaces may be a Low E surface. The more significant of the two exposed surfaces with respect to exhibiting low emissivity is the outermost surface of the first layer stack 32.

Particularly for applications in which the voids 26 and 28 provide trapped pockets of a dry inert gas, such as argon, the power-generating layers of the layer stack 34 may be organic solar cells, since the layers will be protected from moisture. Organic-based solar cells are less expensive to manufacture and the fabrication process has a smaller negative environmental impact than conventional semiconductor-based solar cells.

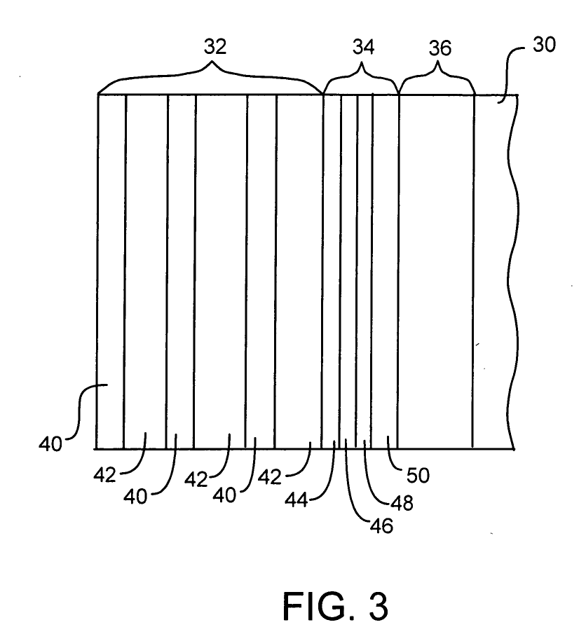

FIG. 3 shows one embodiment of a sequence of layers on the PET sheet 30 of FIG. 2. A first layer stack 32 comprises a three-period Dynamic Bragg Reflector (DBR). By way of example, the three layer pairs within the DBR may be a layer 40 of SiN having a thickness of 75 nm and a second layer 42 of SiO₂ having a thickness of 111 nm. The third layer “stack” 36 is a single layer of silver which simultaneously functions as a partial mirror and an electrode for the organic solar cell formed by the second layer stack 34. The silver mirror may have a thickness of 200 nm.

Within the layer stack 34, a first layer 44 functions as the other electrode. This layer may be a thin film of ITO, such as a film having a thickness of 15 nm. The adjacent layer 46 may be formed of PEDOT:PSS (PolyEthyleneDiOxyThiothene:PolyStyreneSulfonate). A suitable thickness is 32 nm.

Layer 48 represents the donor and acceptor materials. As one possible donor material, copper pthalocyanine (CuPc) may be used. An acceptable acceptor material is perylenetetracarboxylic bis-benzimidazole (PTCBI). The ratio of the materials may be one-to-one, with a thickness of 10 nm.

The final layer 50 within the stack 34 may be an exciton-blocking layer of bathocuproine (BCP). This layer may have a thickness of 50 nm. The combination of layers of the stacks 34 and 36 provides the photovoltaic properties for generating power in response to photon reception. Still, the organic solar cell is generally transparent and generally neutral within the visible light spectrum.

As compared to the above description, variations of the three layer stacks 32, 34 and 36 are available without diverting from the present invention. For example, the three-period DBR of the first layer stack 32 may instead be a six-period DBR or may be some other layer arrangement which achieves wavelength selectivity. Antireflection between the organic solar cell and the sun is beneficial, since any reduction in reflectivity increases the solar energy available for conversion at the solar cell. As a separate consideration, the third layer stack 36 may be a series of layers that contribute to the wavelength selectivity. The wavelength selectivity for the third layer stack may be designed to provide some reflection back to the organic solar cell while still allowing the completed assembly to function as a window.

As is known in the art, organic solar cells are different from semiconductor-based solar cells in that there is no reliance on a large built-in electrical field of a PN junction to separate electrons and holes that are generated as photons are absorbed. As previously noted, the layer 48 is formed of a donor material and an acceptor material. Typically, a photon is converted into an electron hole pair within the donor material. Charges tend to remain bound in the form of an exciton, but are separated when the exciton diffuses to the donor-acceptor interface. However, while the organic solar cells are not reliant on the large electric field of a PN junction, the organic solar cells will be represented as diodes in FIGS. 5 and 6.

A number of different factors will contribute to the light absorption at the second layer stack 34 that forms the energy conversion. As previously noted, absorption for a given level of solar energy can be increased by providing antireflection at the “entrance” to the layers that form the organic solar cell and/or providing reflectivity at the “exit” side. Additionally, it has been determined that light scattering can be used to enhance absorption as much as twenty-five percent, as compared to circumstances that are limited to normal incidence. Surface irregularities may be incorporated onto any of a number of different layers shown in FIG. 3 to provide scattering. For example, one or all of the dielectric layers of the DBR of the first layer stack 32 may be formed to include surface irregularities. Alternatively, a grating layer that is specifically fabricated to include surface irregularities for light scattering may be added to the first or third layer stacks 32 and 36. As yet another possibility, one of the electrodes of the solar cell may be intentionally roughened. In addition to inherent roughness, techniques may be employed to achieve a more effective scattering. Merely by way of example, metal nanoparticles may be intentionally introduced, such as providing silver nanoparticles at the interface of the active layers with the electrode.

It is also possible to increase the efficiency of the organic solar cell 34 by utilizing light trapping. In addition to the use of a silver reflecting layer as the third layer “stack” 36, the first layer stack 32 may be formed to provide reflectance of light from the direction of the second layer stack 32, while the three layer stacks are formed to ensure that the assembly can still function as a window.

Another consideration is optical interference. This factor plays a significant role in the efficiency of absorption by the organic solar cell. Efficiency is maximized if the active layers are located at the maxima of the optical field intensity.

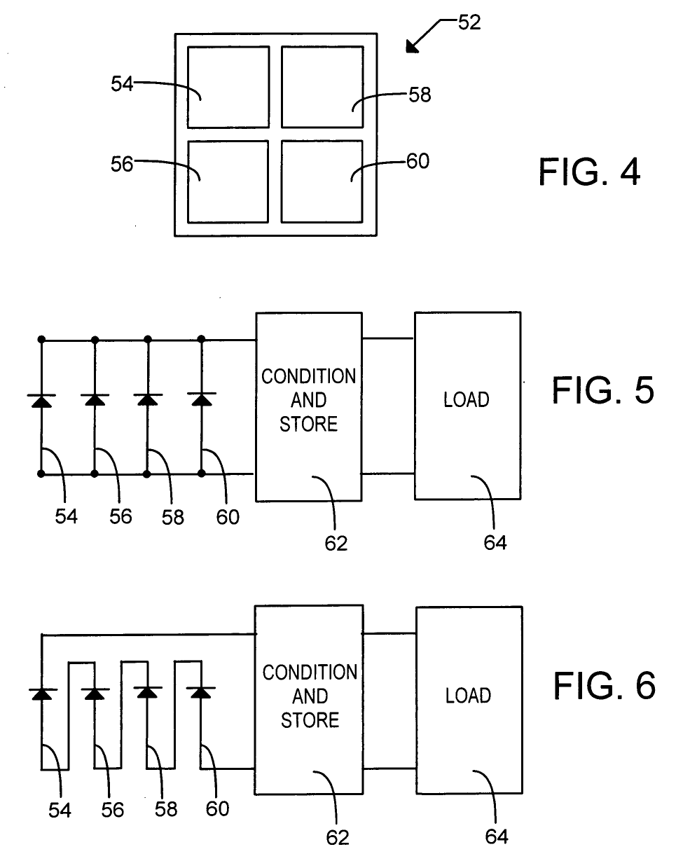

Referring now to FIG. 4, an example of a window 52 in accordance with the invention is shown as including four large-scale organic solar cells 54, 56, 58 and 60. In other embodiments, there may be a single large-scale solar cell or an array that includes a much greater number of cells. For a person looking through the window 52, the area between two cells is preferably not easily identified. As previously noted, this is possible by providing blanket depositions of nearly all of the layers, but patterning a critical layer, such as an electrode layer.

FIGS. 5 and 6 show alternative approaches to interconnecting the organic solar cells 54, 56, 58 and 60. In FIG. 5, the solar cells are connected in parallel to a component 62 for providing energy conditioning and storage. This component may be a conventional unit used in known solar cell systems. The energy that is generated may be used to power a load 64, such as internal lights or air conditioning. In FIG. 6, the organic solar cells are connected in series, but all other aspects are identical to FIG. 5.

What is claimed is:

1. A window for use along a wall of a structure so as to separate an interior from an exterior of said structure, said window comprising:
parallel first and second rigid transparent members; and
a tensioned flexible substrate located between but spaced apart from said first and second rigid transparent members by fixed volumes of gas, said tensioned flexible substrate having a plurality of layers formed thereon, including filter layers which are cooperative to provide desired wavelength filtering properties and further including power generating layers which are cooperative to provide photovoltaic properties, wherein transmissivity of visible light along a path that intersects both said filter and power generating layers is at least twenty percent.

2. The window of claim 1 wherein said power generating layers comprise materials which define an organic solar cell and wherein said fixed volumes of gas are sealed within areas between said tensioned flexible substrate and said first and second rigid transparent members.

3. The window of claim 2 wherein said gas is primarily an inert gas.

4. The window of claim 1 wherein said power generating layers are thin film layers which define a large area, generally transparent solar cell within a central viewing area of said window, said solar cell being an organic solar cell.

5. The window of claim 4 wherein said power generating layers define a plurality of said generally transparent solar cells which are connected to provide electrical power that is directed from said window.

6. The window of claim 5 wherein at least one of said filter layers which are cooperative to provide said wavelength filtering properties also functions as an electrode for said power generating layers.

7. The window of claim 2 wherein said plurality of layers further includes reflective layers positioned to direct light to said organic solar cell.

8. The window of claim 1 wherein at least one of said plurality of layers includes surface irregularities configured to induce light scattering that enhances efficiency of said power generating layers.

9. The window of claim 1 wherein an exposed surface of said plurality of layers that is associated with said exterior of said structure exhibits low emissivity (a Low E surface) with respect to radiation of heat.

10. A window separating the interior from the exterior of a structure comprising:
three parallel substrates in which a center substrate is spaced apart from end substrates by areas of trapped gas, said end substrates being transparent and being rigid, said center substrate being flexible and being transparent;
a layer stack configured for wavelength selection with respect to transmission of solar energy, said layer stack being on said center substrate to determine optical properties of said window; and
a solar cell arrangement of layers on said center substrate along a same optical path as said layer stack, said solar cell arrangement occupying at least fifty percent of the area of said center substrate, said layers defining an organic optoelectric capability.

11. The window of claim 10 wherein a solar transmissivity through said same optical path is at least twenty percent, said solar cell arrangement being at least one solar cell having an organic photovoltaic material.

12. The window of claim 10 wherein said layer stack includes an outer conductive layer which is cooperative with other layers of said layer stack to provide solar control, said conductive layer simultaneously being an electrode layer of said solar cell arrangement.

13. The window of claim 10 wherein at least one said area of trapped gas contains an inert gas to retard degradation of said solar cell arrangement.

14. The window of claim 10 wherein said solar cell arrangement comprises a plurality of organic solar cells.

15. A window comprising:
a frame;
first and second glass panes secured in parallel relationship by said frame;
a polymeric member tensioned within said frame between said first and second glass panes such that areas of trapped inert gas reside between said polymeric member and said first and second glass panes, said polymeric member having a wide area viewing region through which transmissivity in the visible light range is at least twenty percent, said wide area viewing region having a coating thereon, said coating including a first layer sequence that forms an organic solar cell and a second layer sequence that forms a mirror positioned to direct solar energy to said organic solar cell so as to enhance efficiency of photoelectric conversion, wherein visible light through said coating has a transmissivity of at least twenty percent.

16. The window of claim 15 wherein said second layer sequence includes a Dynamic Bragg Reflector (DBR).

17. The window of claim 15 wherein said coating includes surface irregularities to induce light scattering so as to further enhance said efficiency of photoelectric conversion.

18. The window of claim 15 wherein said areas of trapped inert gas contain argon.
